(19) United States
(12) Patent Application Publication
(10) Pub. No.: US 2026/0210309 A1
(43) Pub. Date: Jul. 23, 2026

(54) METHOD FOR CONTROLLING AN EXECUTION OF FUNCTIONS DURING THE OPERATION OF AN INTERNAL COMBUSTION ENGINE

(71) Applicant: Robert Bosch GmbH, Stuttgart (DE)

(72) Inventor: Alexander Weins, Renningen (DE)

(21) Appl. No.: 19/423,558

(22) Filed: Dec. 17, 2025

(30) Foreign Application Priority Data
Dec. 18, 2024 (DE) 10 2024 212 137.1

(51) Int. Cl. F02D 41/38; F02D 41/30

(52) U.S. Cl. CPC F02D 41/3809; F02D 41/3076

(57) ABSTRACT

A method for controlling an execution of a function during operation of an internal combustion engine. The internal combustion engine has a plurality of combustion chambers, one combustion chamber being partially arranged in a combustion chamber housing or cylinder, and an injector is allocated to each combustion chamber, which is supplied with fuel. For a group of a plurality of combustion chambers, and for the injectors allocated to this plurality of combustion chambers, at least one execution of a function is initiated, with which, from an actuation property, at least one sequence of properties of at least one injector of the group is to be determined. For the group of the plurality of combustion chambers, only one function for recognizing a state of the fuel accumulator is assigned, to allocate the sequence of properties of the injector to at least one specific injector of a specific combustion chamber of the group.

### BACKGROUND INFORMATION

Germany Patent Application No. DE 10 2013 225 152 A1 describes a method for calibrating an injection insert with a high-pressure accumulator of an internal combustion engine. It is provided to calibrate a so-called pre-injection quantity regularly, since this pre-injection quantity changes over the course of the service life of the components due to drift effects. The pre-injection is usually, inter alia, calibrated under so-called overrun boundary conditions. The motor vehicle is in so-called overrun operation, which is also occasionally referred to as coasting operation. In a motorized motor vehicle, this refers to the driving state in which the internal combustion engine is in this case hauled by the motor vehicle. In this case, there is a non-disconnected friction-fitted connection between the internal combustion engine and the rotationally moving wheels of the motor vehicle, i.e., a normal driving clutch between the internal combustion engine and the transmission is not disconnected, i.e., closed. The overrun or coasting operation also occurs in motor vehicles with an automatic transmission and a hydrodynamic converter.

Germany Patent Application No. DE 10 2017 117 677 A1 describes a method for calibrating injectors and an injection system. According to this document, regular calibration of the injectors is necessary. A plurality of injectors are calibrated simultaneously by injecting fuel into the combustion chambers of a plurality of cylinders. One cylinder is allocated to each injector. The calibration is to be carried out in the overrun operation of the motor vehicle. In this operating state, the internal combustion engine and thus the cylinders require no power. Therefore, this phase is particularly suitable for the injector calibration. The fuel injection takes place, for example, during an exhaust stroke into the combustion chamber.

### SUMMARY

According to a first aspect of the present disclosure, a method for controlling an execution of at least one function during the operation of an internal combustion engine is provided, wherein the internal combustion engine has a plurality of combustion chambers, and a combustion chamber is arranged partially in a combustion chamber housing, preferably a cylinder, and an injector is allocated to each combustion chamber, which injector is supplied with fuel from a fuel accumulator. According to an example embodiment, for a group of a plurality of combustion chambers and for the injectors allocated to this plurality of combustion chambers, at least one execution of a function is initiated, with which, from an actuation property, at least one sequence of properties of at least one injector of the group is to be determined. For the group of the plurality of combustion chambers, only one function for recognizing a state of the fuel accumulator is assigned, in order to allocate, to at least one specific injector of a specific combustion chamber of the group, the sequence of properties (“actuation property sequence”) of the injector.

A combustion chamber housing can be, for example, a cylinder of a reciprocating-piston machine or a combustion chamber of a rotary-piston machine within a disk. In reciprocating-piston machines, a combustion chamber can be arranged completely or partially in the cylinder. The internal combustion engine is preferably designed as a four-stroke machine that passes through an intake stroke, a compression stroke, a power stroke, and an exhaust stroke.

A group of a plurality of combustion chambers of an internal combustion engine can comprise or have, for example, all combustion chambers of the internal combustion engine. Thus, this group can comprise, for example, all four, all six, all eight, all twelve or more combustion chambers. A group of a plurality of combustion chambers of an internal combustion engine can also comprise or have only a subset of all combustion chambers of the internal combustion engine: an internal combustion engine can have, for example, a plurality of cylinder banks (combustion chamber banks). A so-called V engine can have, for example, two banks with two cylinders each (V4 engine), with three cylinders each (V6 engine), or with four cylinders each (V8 engine) or more cylinders or combustion chambers per bank. Accordingly, such a subset can have, for example, all combustion chambers of one bank of two banks, e.g., two of four, three of six, four of eight and so on.

An injector is allocated to each combustion chamber in such a way that a quantity of fuel discharged by this injector—for example, by injection or blowing—reaches the allocated combustion chamber. For this purpose, the injector has an outlet (main outlet) that opens into the allocated combustion chamber. The outlet is opened and closed by movement of a closure (for example, a needle). An opening movement of the closure is caused by actuating an actuator (electric magnet) of the injector. A further outlet of the injector (secondary outlet) is a return outlet that conducts an operationally-caused fuel leakage flow away from the injector.

According to an example embodiment, the initiated method is intended to determine, from an actuation property, which can be, for example, an actuation time of the injector, at least one sequence of properties of the at least one injector of the group that is actuated during the method. The property can, for example, be a determined quantity of fuel. This allows correct functioning of an injector to be checked.

If, as provided, only one function for recognizing a state of the fuel accumulator is assigned for the group of a plurality of combustion chambers, several advantages result: thus, for example, a time advantage would result compared with a method in which, for each injector of a group, a phase would be provided with the execution of a function for recognizing a state of the fuel accumulator. Each individual execution of a function for recognizing a state of the fuel accumulator requires time, so that, in an overrun phase in which only one execution of a function for recognizing a state of the fuel accumulator is assigned for a group of injectors, more time is available to execute the individual sequences of the functions at the injectors. Consequently, all injectors can have been checked for correct functioning earlier. Compared to Situation 1 described later, in which functions FZ for recognizing a state of the fuel accumulator and functions F1 for delivering a test injection quantity alternate according to the scheme F1-FZ-F1-FZ F1-FZ-F1-FZ-F1-FZ-F1-FZ, this results in a significant time advantage: whereas, in Situation 1, 100% (15 s) would be required, the time expenditure with the aforementioned change is only 58.3% (8.75 s). In view of the more frequent decoupling of the internal combustion engine from the drivetrain in modern vehicle concepts, and thus overrun phases occurring less frequently and for shorter durations, the proposed modified approach has a higher probability of complete performance of the tests compared to Situation 1.

According to a further aspect of the present disclosure, the function for recognizing a state of the fuel accumulator is assigned before a start of a first introduction phase, for this method or this execution, of the specific injector of a specific combustion chamber of the group. From this shifting or placing or setting of the function for recognizing a state of the fuel accumulator before a start of a first introduction phase of the specific injector, the advantage arises, for example, that futile introduction of fuel within the framework of the method can be avoided to the greatest extent possible. If a function for recognizing a state of the fuel accumulator is assigned before a first introduction phase, but this function for recognizing a state of the fuel accumulator is not completed, it can be provided to not allow this introduction phase to run at all. Especially in comparison with other method positions proposed here for a function for recognizing a state of the fuel accumulator. If a function for recognizing a state of the fuel accumulator were assigned after a first introduction phase, but this function for recognizing a state of the fuel accumulator were not completed, i.e., a state of the fuel accumulator were not recognized or determined, then this introduced quantity of fuel would have been futilely introduced for this method. In an unfavorable case, this quantity of fuel would have passed unused through the exhaust train into the environment. In a less unfavorable case, this quantity of fuel could additionally be used to improve a state of a filter (e.g., particulate filter) in the exhaust train.

According to a further aspect of the present disclosure, this one function for recognizing a state of the fuel accumulator would be assigned after the start of a first introduction phase of the specific injector of a specific combustion chamber of the group. From this, an almost optimal approach would result, i.e., in the most unfavorable case, only a quantity of fuel of one injector would have been introduced without being used. In particular, the function for recognizing a state of the fuel accumulator would be assigned after the end of a first introduction phase of the specific injector of a specific combustion chamber of the group.

According to a further aspect of the present disclosure, a learning value is generated with the sequence of properties allocated to one injector, in particular a fuel quantity, which learning value is allocated to the injector. In particular, when an ideal sequence of properties is indeed allocated to the actuation property, but this is not achieved in practical use, i.e., is too large or too long or too small or too short, a modified actuation property is generated for practical use (not test operation) in normal driving operation (drive). This modified actuation property corresponds to a learning value. If, in response to an actuation property, the sequence of properties were too large or too long, for example a fuel quantity were too large, a learning value would follow therefrom, which would be an actuation time and, as the learning value, it would be a shorter actuation time, in order to achieve, i.e. to introduce, more accurate sequences of properties such as quantities of fuel in the future. If, in response to an actuation property, the sequence of properties were too small or too short, for example a fuel quantity were too small, a learning value would follow therefrom, which would be an actuation time and, as the learning value, it would be a longer actuation time, in order to achieve, i.e. to introduce, more accurate sequences of properties such as quantities of fuel in the future.

The present disclosure is explained in more detail using the figures and example embodiments.

### BRIEF DESCRIPTION OF THE DRAWINGS

FIG. 1 is a basic representation of a motor vehicle comprising an internal combustion engine with six cylinders.

FIG. 2 shows a schematic sequence of the method according to an example embodiment of the present disclosure.

FIG. 3 is a schematic representation of an in-line engine, here as a six-cylinder in-line engine, with a cylinder bank as shown in FIG. 1.

FIG. 4 shows a first method for application to the in-line engine according to FIG. 3, according to an example embodiment.

FIG. 5 shows a second method for application to the in-line engine according to FIG. 3, according to an example embodiment.

FIG. 6 is a schematic representation of a V engine, here as an eight-cylinder engine in a V arrangement, with two cylinder banks and a fuel accumulator (for example, a high-pressure accumulator) for both cylinder banks, according to an example embodiment.

FIG. 7 is a schematic representation of a V engine, here as an eight-cylinder engine in a V arrangement, with two cylinder banks and a fuel accumulator (for example, a high-pressure accumulator) for each cylinder bank, according to an example embodiment.

### DETAILED DESCRIPTION OF EXAMPLE EMBODIMENTS

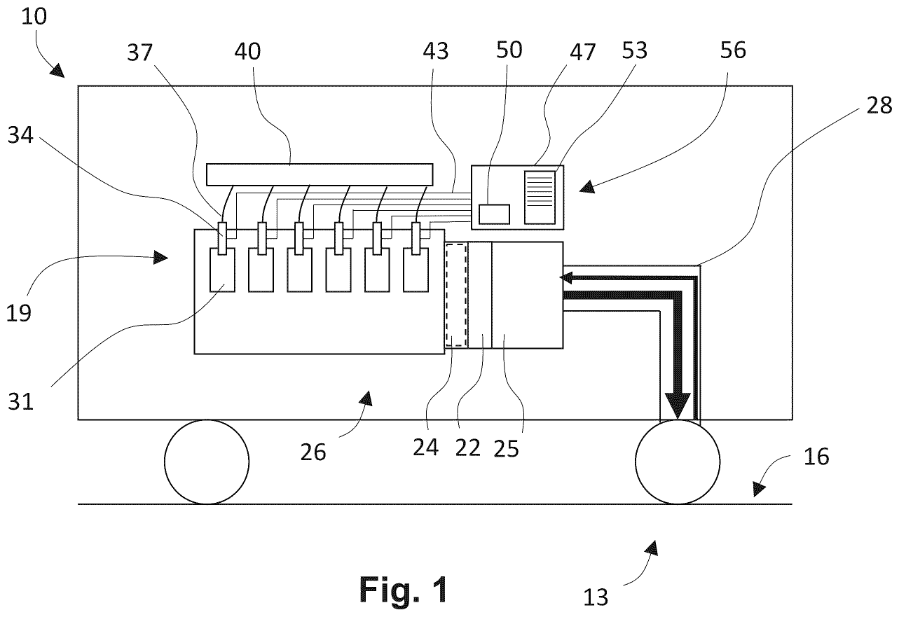

FIG. 1 shows a motor vehicle 10, which has at least one drive means 13, preferably in the form of at least one wheel. The motor vehicle 10 with the drive means 13 stands on a ground 16 and typically moves on this ground 16. The motor vehicle 10 also has an internal combustion engine 19, which is connected to a transmission 25 by means of a clutch 22. The internal combustion engine 19, the clutch 22 and the transmission 25 are part of a drivetrain 26. The transmission 25 supplies a further part of the drivetrain 26, the drivetrain part 28, with mechanical energy (torque, rotational speed) and thus drives the drive means 13. If the internal combustion engine 19 drives the motor vehicle 10, the internal combustion engine 19 drives (rotational speed, torque) a drive shaft (not shown here), which drives a clutch input part of the clutch 22. If the clutch 22 is switched to transmit torque, a clutch output part transmits mechanical energy to an input shaft of the transmission 25. Depending on the selected gear stage in the transmission 25, the mechanical energy is passed, with an output speed dependent thereon and an output torque dependent thereon, to the drivetrain part 28 and is transmitted to the drive means 13. This describes the drive state of the motor vehicle 10.

So that the internal combustion engine 19 can transmit a torque, fuel is introduced into the individual combustion chambers 31 in a conventional manner, is ignited, and the torque on a crankshaft as a drive shaft is generated by the intended combustion in the individual combustion chambers 31. Fuel is Supplied to the injectors 34 via individual fuel supply lines 37, supplied from a fuel accumulator 40—for example, a high-pressure accumulator—for fuel (for example, common rail). For this purpose, the individual injectors 34 are actuated by a control unit 47. For this purpose, energy is supplied, via electrical connections 43, at the correct times, to drive elements (for example, an electric magnet) of the injectors 34 that are not shown here, so that outlets (main outlets) of the injectors 34 can open. A processor 50 in which the provided commands are processed is located in the control unit 47. In addition, a storage medium 53 for—particularly digital—data is preferably located in this control unit 47. These data in this storage medium 53 can, for example, comprise a computer program 56, which is designed to execute all steps of one of the methods or which is programmed in such a way that it executes a method when it is executed on a computer (processor 50, control unit 47).

During operation of the internal combustion engine 19, it is provided that various functions are executed on the internal combustion engine 19. These functions include, for example, the function F1. The function F1 can be, for example, a so-called “Railpressure-based Pilot Calibration” (RPC). Such a function F1 serves to determine, from a—preferably uniform—actuation property such as an injector actuation duration tinj (actuation duration of an injector), as a result of the individual actuation property, at least one individual property—for example, an introduced quantity of fuel such as liquid gasoline or diesel or gaseous hydrogen—of each injector 34 of a group 76 of combustion chambers 31. Preferably, the introduction of fuel for this method starts during a power stroke—e.g., at an end of a power stroke before an opening of the combustion chamber 31 to an exhaust tract (opening of an outlet)—or after the opening of the combustion chamber 31 to an exhaust tract, or with, or after, a start of an expelling process by a piston (exhaust stroke).

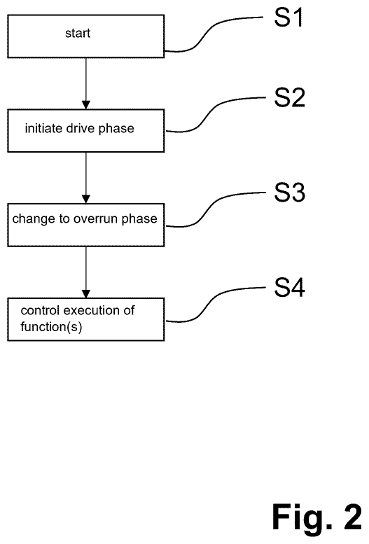

If a motor vehicle 10 is started, FIG. 2, (start), typically thereafter a drive phase S2 is initiated and performed in the first instance. During such a drive phase, mechanical energy is transmitted via the drivetrain 26 onto or to the drive means 13 so that the motor vehicle 10 can move on the ground 16 in the driven state. If, for example, such a motor vehicle 10 is moved in the inner city and if, for example, this motor vehicle 10 approaches a traffic light signaling “stop,” the operating mode of the motor vehicle 10 is typically changed from a drive phase S2 to an overrun phase S3. In this overrun phase S3, the internal combustion engine 19 does not provide any mechanical energy; rather, this internal combustion engine 19 receives energy in the overrun phase S3, which is symbolically depicted by the narrower arrow between the drive means 16 and the transmission 25 (FIG. 1). The wide arrow symbolizes the case of transmitting drive energy from the internal combustion engine 19 to the drive means 13. The start of the method for controlling an execution of at least one function such as F1 or FZ occurs in a step S4 after the start of the overrun phase S3.

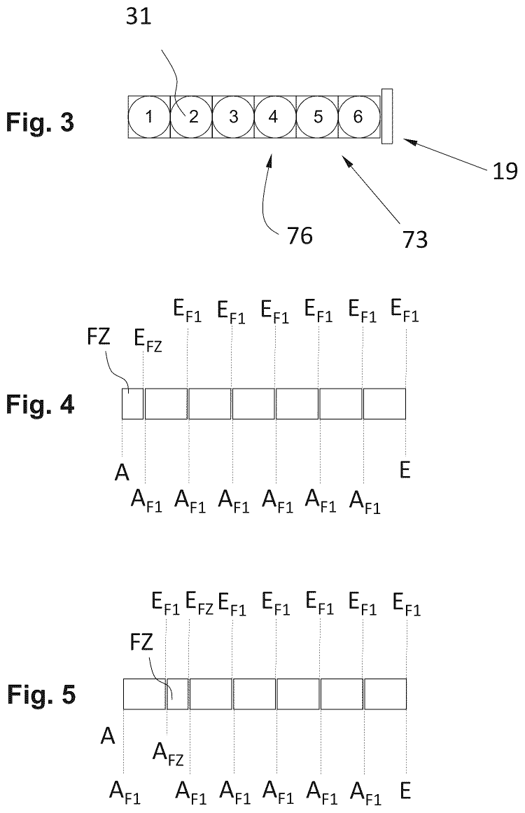

FIG. 3 shows a schematic representation of an in-line engine, here as a six-cylinder in-line engine, with a cylinder bank 73, which in this case determines a group 76 of a plurality of combustion chambers 31 having the numbers 1, 2, 3, 4, 5, and 6. A so-called ignition sequence is 1-5-3-6-2-4, i.e., a sequence of introductions of fuel into the combustion chambers 31 is to be carried out after the start of an overrun phase in this order specified by the ignition sequence. The method is described below based on an exemplary embodiment according to FIG. 4.

In FIG. 4, a first sequence for an internal combustion engine 19 is shown, which is ideal as such here, since it is performed from the intended start A to an end E without interruption. The start A is determined by an event that is the start of an overrun phase. At the start of the method, a function FZ is assigned for the sequence, which moreover runs through completely or is executed completely and ends at Erz (end of function FZ). By means of the function FZ, a state recognition is performed, i.e., a state of the fuel accumulator is determined. Within the framework of this state recognition, it is determined, for example, how large a leakage of fuel from the fuel accumulator 40 (for example high-pressure region, common rail) is. Such a determination of leakage can, for example, rely on models. Without this state recognition FZ, a determination of an average introduced fuel quantity mV1mitt would be expected to be erroneous. After the end E_{FZ} of the execution of the function FZ, a function F1 is assigned and begun to be executed for the combustion chamber 31 having the number 1 of the cylinder having the number 1, preferably as quickly as possible. Here, “timely” means, for example, (compare with the explanations above) that this starts, for example, after a start of an expelling process by a piston (exhaust stroke). As intended, the function F1 causes the injector 34 of the combustion chamber 31 having the number 1 to perform a test injection (or test introduction) with a defined actuation duration tA, by which a test target injection quantity mV1 of, for example, 10 mm3 is introduced into the combustion chamber 31 having the number 1. This process is carried out within the framework of this function F1, which is invoked once, for a predetermined or specific number n1 of test injections into this combustion chamber 31 having the number 1, for example a total of ten times. The function F1 starts at AF1. Preferably, each of these ten test injections into this combustion chamber 31 having the number 1 starts, for example, after a start of an expelling process by a piston (exhaust stroke of the piston of the combustion chamber 31 having the number 1). Accordingly, in each particular stroke only one test injection is introduced into this combustion chamber 31 having the number 1. The corresponding drive shaft or crankshaft executes a number of 2*n1 revolutions during this predetermined number n1 of test injections; in the example, these are 20 revolutions. The function F1 ends at E_{F1}. For the number of n1 test injections into this combustion chamber 31 having the number 1, an average introduced fuel quantity mV1mitt can then be determined by means of conventional methods while taking into account the determination of the leakage. For the assumption that a value of 9.8 mm3 has been determined for the average introduced fuel quantity mV1mitt, an actuation duration tA is then generally to be increased (determination of a learning value), so that in the future the test target injection quantity mV1 and other target injection quantities for other operating points of the internal combustion engine 19 can be achieved with better approximation. In an analogous manner, for the assumption that a value of 10.2 mm3 has been determined for the average introduced fuel quantity mV1mitt, an actuation duration tA is then generally to be reduced (determination of a learning value), so that in the future the test target injection quantity mV1 and other target injection quantities for other operating points of the internal combustion engine 19 can be achieved with better approximation.

After these first 20 revolutions, the method continues in the same manner with the next combustion chambers 31 having the numbers 2 to 6, i.e., corresponding to the ignition sequence.

Corresponding to what has been described above, the internal combustion engine 19 performs a number of 120 test revolutions during the execution of the functions F1, or a number of test revolutions that is twice the number of test injections. Under the assumption of a situation in which a rotational speed n19 of the drive shaft or crankshaft of the internal combustion engine 19 is n19=1200/min=20/s, the pure execution of the functions F1 lasts for a time t=6 s. Under the assumption that the execution of the function FZ requires 1.25 s, a total test time to test all injectors 34 once accordingly is 7.25 s.

If—based on this example according to FIG. 3 and FIG. 4—an interruption of the overrun operation were to occur during the execution of the function FZ, not a single function F1 would have been completed and accordingly not a single fuel quantity mV1 would have been wasted.

In FIG. 5, a second sequence for an internal combustion engine 19 is shown, which is ideal as such here, since it is performed from the intended start A to an end E without interruption after the start of the overrun phase. The only difference from the exemplary embodiment according to FIG. 4 is that the function FZ runs through completely after a first complete execution of the function F1, and only then do the further functions F1 follow.

Below, with reference to parts of a section of a common cycle (FTP 75), it is indicated by way of example which differences may arise.

Section of a cycle, Example 1: Six overrun phases are to be passed through, each overrun phase is to last 0.5 s, so that an overall duration of 3 s would result for these six overrun phases. Each function FZ for the necessary recognition of a state of the fuel accumulator 40 should take 1.25 s. A function F1 requires 20 immediately successive revolutions in order to carry out ten specified test injections of 10 mm3 each. From these 10 injections, a mean value of an average introduced fuel quantity mV1mitt would be determined.

Situation 1: By way of example for comparison purposes, an internal combustion engine 19 designed as an in-line six-cylinder engine is assumed, in which first a function F1 (combustion chamber 1, 20 revolutions at 1.25 s) and then a function FZ at 1.25 s run sequentially. Under the same conditions, executions of the functions F1 for the combustion chambers 5, 3, 6, 2, and 4 and executions of the function FZ then follow alternately (scheme F1-FZ-F1-FZ-F1-FZ-F1-FZ-F1-FZ-F1-FZ). In order for all functions to run as intended, a minimum duration of 15 s would be required to test all injectors 34. Since the functions F1 are to run first, which allow 6 test injections in the respectively available time of 0.5 s before the overrun phase is aborted, however no function FZ can run because the short duration of an overrun phase does not allow this, in such a length of overrun phases only 6 injections are carried out in each case. Thus, a mean value of an average introduced fuel quantity mV1mitt cannot be determined, and thus also no learning value for an improved actuation of the injectors 34. A total of 36 test injections amounting to a total of 360 mm3 would have been futilely carried out. In such a situation, this fuel quantity would have to be capable of being processed by an exhaust gas system (catalytic converter) in order ideally not to emit hydrocarbons into the environment.

Situation 2: This situation corresponds to the method shown in FIG. 4 (FZ at 1.25 s, F1 at 1.25 s each). A total duration of 7.5 s would be assumed for all functions F1. In order for all functions to be able to run as intended, a minimum duration of 8.75 s would be required to test all injectors 34. After the Start of the function FZ, this is aborted after 0.5 s due to abortion of the overrun phase, and no functions F1 are performed. Accordingly, no test injection is carried out, which thus would also not have to be processed by the exhaust gas system in order ideally not to emit hydrocarbons into the environment. A mean value of an average introduced fuel quantity mV1mitt can thus also not be determined here, and thus also no learning value for an improved actuation of the injectors 34. The minimum duration compared with Situation 1 would, in the case of no abortion, be significantly reduced to only 58.3% of the time.
Situation 3: This situation corresponds to the method shown in FIG. 5 (FZ at 1.25 s, F1 at 1.25 s each). A total duration of 7.5 s would be assumed for all F1. In order for all functions to be able to run as intended, a minimum duration of 8.75 s would again be required to test all injectors 34. After the start of the function F1 and six injections, this is aborted after 0.5 s due to termination of the overrun phase, and no function FZ is performed. A total of 6 test injections amounting to a total of 60 mm3 would have been futilely carried out. In such a situation, this fuel quantity would have to be capable of being processed by an exhaust gas system (catalytic converter) in order ideally not to emit hydrocarbons into the environment. A mean value of an average introduced fuel quantity mV1mitt can thus also not be determined here, and thus also no learning value for an improved actuation of the injectors 34. The minimum duration compared with Situation 1 would, in the case of no abortion, be significantly reduced to only 58.3% of the time.

Section of a common cycle (FTP 75), Example 2: Six overrun phases are to be passed through, each overrun phase being intended to last 1 s, so that an overall duration of 6 s would result for these six overrun phases. Each function FZ for the recognition of a state of the fuel accumulator 40 should take 1.25 s. A function F1 requires 20 immediately successive revolutions in order to carry out ten test injections of 10 mm3 each. From these 10 injections, a mean value of an average introduced fuel quantity mV1mitt would be determined.

For Situation 1, no formation of learning values would result, with 72 futile test injections amounting to 720 mm3 (0.72 cm3).

For Situation 2, no formation of learning values would result, with 0 futile test injections.

For Situation 3, no formation of learning values would result, with 50 futile test injections amounting to 500 mm3 (0.5 cm3).

Over the total number of 87 overrun phases of the mentioned cycle, which have individual lengths between 0.5 s and 45 s and frequencies between 1 and 6, for Situation 1 in total the formation of 358 learning values and 768 futile test injections amounting to 7680 mm3 (7.68 cm3 ) results. For Situation 2, in total the formation of 324 learning values and 306 futile test injections amounting to 3060 mm3 (3.06 cm3 ) results. For Situation 3, in total the formation of 605 learning values and 624 futile test injections amounting to 6240 mm3 (6.24 cm3) results.

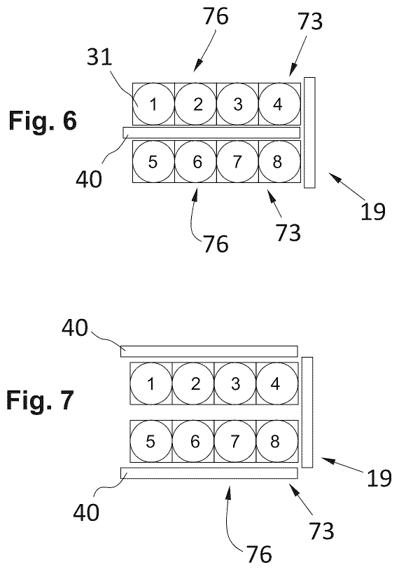

In another exemplary embodiment of such a motor vehicle 10 according to FIG. 1, it can additionally be provided that an electric machine 24 is arranged between the internal combustion engine 19 and the clutch 22. This electric machine 24—operable both as a generator of electric current (“generator mode,” generator) and as a generator of torque (“electric motor mode,” electric motor)—can, for example, generate an “artificial overrun,” i.e., an artificial overrun phase. In this process, the internal combustion engine 19 is hauled by the electrically motor-driven electric machine 24, preferably with the clutch 22 open. This can only be carried out, for example, once the motor vehicle 10 has ended the “rolling” overrun phase, i.e., the vehicle is already stationary. Then, for example after the standstill of the motor vehicle 10, with the clutch 22 open, the electric machine 24 can haul the internal combustion engine 19 (“artificial overrun”), and then one of the methods as described with respect to FIG. 3 to 7 can be applied. Performing the method would have the advantage that during the overrun phase S3, for example, a constant rotational speed n19 (target rotational speed) of the internal combustion engine 19 can be set, so that at least a portion of the boundary conditions is constant whilst the method is being performed.

In a method variant of the other exemplary embodiment of such a motor vehicle 10 according to FIG. 1 mentioned above, it can also be provided that, while the motor vehicle 10 is still rolling, while the internal combustion engine 19 is hauled by the motor vehicle 10—fueled, e.g. for heating an exhaust system of the internal combustion engine 19, or unfueled—the clutch 22 is opened and the electric machine 24 starts to haul the internal combustion engine 19 alone. The method for controlling an execution of at least one function F1 during the operation of an internal combustion engine 19 can, for example, already begin during the hauling/coasting operation of the internal combustion engine 19 by the motor vehicle 10 with the clutch 22 closed, be continued chronologically beyond the opening of the clutch 22, and be ended during the hauling/coasting operation of the internal combustion engine 19 by the electric machine 24. The opening of the clutch 22 can be carried out, for example, at a target rotational speed, and a target rotational speed of the internal combustion engine 19 can then be maintained by the electric machine 24. The target rotational speed upon opening of the clutch 22 and the target rotational speed during the execution of at least one function F1 during the hauling/coasting operation of the internal combustion engine 19 by the electric machine 24 can be different or identical.

In a further method variant, the method during an overrun operation initially takes place only during an overrun of the internal combustion engine 19 by the motor vehicle 10, which transitions into an overrun operation only during an overrun of the internal combustion engine 19 by an electric machine 24, in particular with the clutch 22 open, wherein, between the two overrun operations, the electric machine 24 hauls the internal combustion engine 19 and drives the motor vehicle 10 with the clutch 22 closed.

1-10. (canceled)

11. A method for controlling a sequence of at least one function during operation of an internal combustion engine, wherein the internal combustion engine has a plurality of combustion chambers, each of the combustion chambers being partially arranged in a combustion chamber housing or cylinder, and wherein a respective injector is allocated to each of the combustion chambers, the respective injectors being supplied with fuel from a fuel accumulator, the method comprising:
for a group of a plurality of the combustion chambers, and for the injectors allocated to the group of the plurality of the combustion chambers, initiating at least one execution of a function, with which, from an actuation property, at least one sequence of properties of at least one injector of the group is to be determined;
assigning, for the group of the plurality of combustion chambers, only one function for recognizing a state of the fuel accumulator, in order to allocate the at least one sequence of properties of the at least one injector to a specific injector of a specific combustion chamber of the group.

12. The method according to claim 11, wherein the function for recognizing the state of the fuel accumulator is assigned before a start of a first introduction phase of the specific injector of the specific combustion chamber of the group.

13. The method according to claim 11, wherein the function for recognizing the state of the fuel accumulator is assigned after a start of a first introduction phase of the specific injector of the specific combustion chamber of the group.

14. The method according to claim 11, wherein the specific injector carries out an introduction phase, and wherein the function for recognizing the state of the fuel accumulator is carried out before the introduction phase or after the introduction phase.

15. The method according to claim 14, wherein a learning value is generated using the at least one sequence of properties allocated to the specific injection, the learning value being allocated to the specific injector.

16. The method according to claim 11, wherein the execution of the at least one function occurs during the operation of the internal combustion engine in an overrun operation.

17. The method according to claim 16, wherein the overrun operation is selected from:
an overrun operation only during an overrun of the internal combustion engine by a motor vehicle, or
an overrun operation only during an overrun of the internal combustion engine by an electric machine with a clutch open, or
an overrun operation only during an overrun of the internal combustion engine by a motor vehicle, which transitions into an overrun operation only during an overrun of the internal combustion engine by an electric machine with the clutch open, or
an overrun operation only during an overrun of the internal combustion engine by a motor vehicle, which transitions into an overrun operation only during an overrun of the internal combustion engine by an electric machine with a clutch open, wherein between the overrun operations, with the clutch closed, the electric machine hauls the internal combustion engine and drives the motor vehicle.

18. A non-transitory machine-readable storage medium on which is stored a computer program for controlling a sequence of at least one function during operation of an internal combustion engine, wherein the internal combustion engine has a plurality of combustion chambers, each of the combustion chambers being partially arranged in a combustion chamber housing or cylinder, and wherein a respective injector is allocated to each of the combustion chamber, the respective injectors being supplied with fuel from a fuel accumulator, the computer program, when executed by a computer, causing the computer to perform the following steps comprising:
for a group of a plurality of the combustion chambers, and for the injectors allocated to the group of the plurality of the combustion chambers, initiating at least one execution of a function, with which, from an actuation property, at least one sequence of properties of at least one injector of the group is to be determined;
assigning, for the group of the plurality of combustion chambers, only one function for recognizing a state of the fuel accumulator, in order to allocate the at least one sequence of properties of the at least one injector to a specific injector of a specific combustion chamber of the group.

19. A control unit configured to control a sequence of at least one function during operation of an internal combustion engine, wherein the internal combustion engine has a plurality of combustion chambers, each of the combustion chambers being partially arranged in a combustion chamber housing or cylinder, and wherein a respective injector is allocated to each of the combustion chamber, the respective injectors being supplied with fuel from a fuel accumulator, the control unit configured to perform the following steps comprising:
for a group of a plurality of the combustion chambers, and for the injectors allocated to the group of the plurality of the combustion chambers, initiating at least one execution of a function, with which, from an actuation property, at least one sequence of properties of at least one injector of the group is to be determined;
assigning, for the group of the plurality of combustion chambers, only one function for recognizing a state of the fuel accumulator, in order to allocate the at least one sequence of properties of the at least one injector to a specific injector of a specific combustion chamber of the group.
